(19) United States
(12) Patent Application Publication
(10) Pub. No.: US 2021/0126471 A1
(43) Pub. Date: Apr. 29, 2021

(54) SYSTEM AND METHOD FOR MANAGING CHARGE CONTROL OF A BATTERY ARRAY

(71) Applicant: Modulaire Power System Private Limited, Bangalore (IN)

(72) Inventors: Alok Srivastava, Bangalore (IN); Vinod Kumar Singh, Bangalore (IN); Shikhar Srivastava, Bangalore (IN)

(21) Appl. No.: 17/081,296

(22) Filed: Oct. 27, 2020

(30) Foreign Application Priority Data
Oct. 28, 2019 (IN) 201941043694

(51) Int. Cl. H02J 7/00; B60L 58/13; B60L 58/22; H01M 10/44

(52) U.S. Cl. CPC H02J 7/0019; H02J 7/0016; H01M 2220/20; B60L 58/22; H01M 10/441; B60L 58/13

(57) ABSTRACT

Systems and methods are provided for maintaining charge control of a battery array where a plurality of batteries is serially connected. Each of the battery has an odd switch and an even switch. A battery charge current and voltage for each of the battery is controlled by establishing a controlled charging for the batteries. The odd switch is controlled using a Pulse Width Modulation (PWM) signal. An inductor coupled with the battery array supplies stored power to each of the battery of the plurality of batteries. The battery charge current and voltage is managed by either establishing a restricted battery charge current or battery voltage for one of the battery with high SOC or the battery that is to be charged with lower current rate is switched by a lower duty cycle PWM signal while the remaining batteries are charged with a higher duty cycle PWM signal.

### CROSS-REFERENCE TO RELATED APPLICATIONS

This application claims the benefit under 35 U.S.C. § 119 of Indian Patent Application No. 201941043694, filed Oct. 28, 2019, which application is incorporated herein by reference in its entirety.

### FIELD

The present disclosure generally relates to controlling charge and management of batteries present in a battery array. In particular, the present disclosure provides systems and methods to facilitate controlling charging and discharging of the batteries in the battery array.

### BACKGROUND

The background description includes information that may be useful in understanding the present invention. It is not an admission that any of the information provided herein is prior art or relevant to the presently claimed invention, or that any publication specifically or implicitly referenced is prior art.

Generally, power output from an array of a DC power source is degraded in presence of a mismatch between available one or more power sources. For instance in case of a battery array consisting of multiple batteries where the batteries are connected either in series and/or parallel form, power input to the batteries suffers due to mismatch in parameters such as related to State of Health (SOH) related to storage capacity, State Of Charge (SOC), mismatch cell impedance, and uneven temperature rise and so forth.

The distributed power sources battery cells are used with inverters like power backup inverters, solar grid tie inverters, solar hybrid inverters, motor control circuits for electric vehicles, hybrid electric vehicles, and battery charges. However, for managing charging and discharging of each of the batteries an additional battery, balancing circuit, battery management circuit and power optimizer circuit are required. Additionally, the balancing circuit needs be implemented for prevention of overcharging and over discharging of each of voltage and current of the storage cell of the array.

There is therefore a need in the art to provide a single simplified circuit for performing and managing charging, discharging and management of current and voltage of the batteries in a battery array.

### SUMMARY

The present disclosure generally relates to controlling charge and management of batteries present in a battery array. In particular, the present disclosure provides systems and methods to facilitate controlling charging and discharging of the batteries in the battery array.

An aspect of the present disclosure pertains to a method for maintaining charge control of a battery array where a plurality of batteries are serially connected and each of the battery has an odd switch and an even switch, said method comprising: controlling a battery charge current and voltage for each of the battery of the plurality of batteries by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries; managing the battery charge current and the battery voltage for each of the battery of the plurality of batteries by: establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery; and establishing a restricted battery charge current and a restrictive battery voltage for one of the battery of the pluralities of batteries, where at least one of battery that is to be charged with lower current rate is switched by the lower duty cycle PWM signal for pulse charging while rest of the batteries of the plurality of batteries are charged with the higher duty cycle PWM signal for DC charging.

According to an embodiment, upon the odd switch being turned OFF one or more complimentary even switch of the battery array turns ON such that the generated power from the inductor flows through the battery array.

According to an embodiment, the plurality of batteries is serially connected via a switch circuit.

According to an embodiment, the plurality of batteries is connected in series using a string and is disconnected by creating a bypass path for the string.

According to an embodiment, the method facilitates creating a full sine wave by varying a count of the pluralities of batteries.

According to an embodiment, the inductor configured with the battery array facilitates the battery array to act as a boost converter.

According to an embodiment, the even switch and the odd switch are controlled using a Metal Oxide Semiconductor Field Effect Transistor (MOSFET).

According to an embodiment, the PWM signal is received from a microcontroller.

According to an embodiment, a system for maintaining charge control of a battery array where a plurality of batteries are serially connected and each of the battery has an odd switch and an even switch, said system comprising: one or more processors, communicatively coupled to a memory, the memory storing one or more instructions executable by the one or more processors, wherein the one or more processors upon execution of the one or more instructions causes the system to: control a battery charge current and voltage for each of the battery of the plurality of batteries by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries; manage the battery charge current and the battery voltage for each of the battery of the plurality of batteries by: establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery; and establishing a restricted battery charge current and a restrictive battery voltage for one of the battery of the pluralities of batteries, where at least one of battery that is to be charged with lower current rate is switched by the lower duty cycle PWM signal for pulse charging while rest of the batteries of the plurality of batteries are charged with the PWM signal for DC charging.

According to an embodiment, the system is located on a printed circuit board.

A general object of this disclosure is to provide a single circuit for battery management for balancing, charging, and discharging of the batteries of a battery array.

An object of the present disclosure is to facilitate integration and control of large low voltage, low power switch control to achieve high voltage and high power solutions.

An object of the present disclosure is to facilitate providing a compact size high performance power system.

An object of the present disclosure is to facilitate providing a single controller unit for multiple power paths.

An object of the present disclosure is to facilitate disconnecting individual batteries from battery array during run time.

Yet another object of the present disclosure is to facilitate providing accurate measurement of the battery VOC, SOC, and better SOH for better range prediction for electric vehicles.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIGS. 1A-B illustrates as in prior art a conventional electric vehicle power system with DC motor and AC motor respectively, in accordance with an embodiment of the present disclosure;

FIG. 2A illustrates a circuit for the MPPS system, and FIG. 2B indicates the MPPS based single phase power backup inverter, in accordance with an embodiment of the present disclosure;

FIG. 3A illustrates a waveform with charge current as 5 A, and FIG. 3B illustrates a waveform with charge current as 10 A, in accordance with an embodiment of the present disclosure;

FIG. 4A illustrates a waveform for resting battery cell B2, and FIG. 4B illustrates a waveform with average DC current in the battery with odd switch duty cycle, in accordance with an embodiment of the present disclosure;

FIG. 5 illustrates the MPPS system based single phase inverter, in accordance with an embodiment of the present disclosure;

FIGS. 6A-B illustrates a waveform for illustrating low voltage MPPS switches operating at less than 1 KHz switching frequency and generating output voltage with battery cell voltage level resolution, in accordance with an embodiment of the present disclosure.

FIG. 7A illustrates a waveform generated by adjusting modulation index of sine modulated PWM at 0.7 and FIG. 7B illustrates a waveform generated by adjusting modulation index of sine modulated PWM at 0.5 in accordance with an embodiment of the present disclosure;

FIG. 8 illustrates a proposed MPPS based EV power system with DC motor, in accordance with embodiments of the present disclosure;

FIG. 9A illustrates a circuit for showing discharge to motor controller duty cycle controlling modes and FIG. 9B illustrates a waveform generated during battery discharging, in accordance with an embodiment of the present disclosure;

FIG. 10A illustrates a 3-phase AC motor controller with three battery arrays and three MPPS circuits and FIG. 10B illustrates, a 3 phase AC motor control current and voltage waveforms by providing sine modulated PWM in single source of each phase, in accordance with an embodiment of the present disclosure; and,

FIG. 11 illustrates an exemplary flow diagram of the proposed method for maintaining charge control of a battery array, in accordance with an exemplary embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present disclosure generally relates to controlling charge and management of batteries present in a battery array. In particular, the present disclosure provides systems and methods to facilitate controlling charging and discharging of the batteries in the battery array.

An aspect of the present disclosure pertains to a method for maintaining charge control of a battery array where a plurality of batteries are serially connected and each of the battery has an odd switch and an even switch, said method comprising: controlling a battery charge current and voltage for each of the battery of the plurality of batteries by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries; managing the battery charge current and the battery voltage for each of the battery of the plurality of batteries by: establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery; and establishing a restricted battery charge current and a restrictive battery voltage for one of the battery of the pluralities of batteries, where at least one of battery that is to be charged with lower current rate is switched by the lower duty cycle PWM signal for pulse charging while rest of the batteries of the plurality of batteries are charged with the higher duty cycle PWM signal for DC charging.

According to an embodiment, upon the odd switch being turned OFF one or more complimentary even switch of the battery array turns ON such that the generated power from the inductor flows through the battery array.

According to an embodiment, the plurality of batteries is serially connected via a switch circuit.

According to an embodiment, the plurality of batteries is connected in series using a string and is disconnected by creating a bypass path for the string.

According to an embodiment, the method facilitates creating a full sine wave by varying a count of the pluralities of batteries.

According to an embodiment, the inductor configured with the battery array facilitates the battery array to act as a boost converter.

According to an embodiment, the even switch and the odd switch are controlled using a Metal Oxide Semiconductor Field Effect Transistor (MOSFET).

According to an embodiment, the PWM signal is received from a microcontroller.

According to an embodiment, a system for maintaining charge control of a battery array where a plurality of batteries are serially connected and each of the battery has an odd switch and an even switch, said system comprising: one or more processors, communicatively coupled to a memory, the memory storing one or more instructions executable by the one or more processors, wherein the one or more processors upon execution of the one or more instructions causes the system to: control a battery charge current and voltage for each of the battery of the plurality of batteries by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries; manage the battery charge current and the battery voltage for each of the battery of the plurality of batteries by: establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery; and establishing a restricted battery charge current and a restrictive battery voltage for one of the battery of the pluralities of batteries, where at least one of battery that is to be charged with lower current rate is switched by the lower duty cycle PWM signal for pulse charging while rest of the batteries of the plurality of batteries are charged with the PWM signal for DC charging.

According to an embodiment, the system is located on a printed circuit board.

In an embodiment, a Modular Programmable Power system (MPPS) is provided. The MPPS herein is also referred to as system 100. The system 100 facilitates providing a single phase power backup inverter circuit with a battery charger with a boost PFC, for battery management and battery balancing, and provides a single phase inverter by same circuit. During charging mode the system 100 can be programmed so that the system can work like a charger (DC/DC converter with current and voltage control) along with battery management. During power outage bypass—relay disconnect grid AC source and battery and inverter start supporting local AC load, during this time the system functions like a single phase inverter and for battery management. The system makes a single phase inverter with multi-level method, and number of levels equals to 2x+1, where x is equals to number of cells in battery stack. The system can generate sine wave <0.5% THD with 21 levels i.e. with 10 cell stack or more.

In an embodiment, during an electronic vehicle (EV) running on road, a motor controller can provide a required power to DC motor load, and at this time the system functions like a battery management system and a DC motor controller. Additionally, during the EV running on the road, motor controller can provide required power to AC motor load with three parallel MPPS circuits with phase shift, at this time the MPPS functions like battery management system and AC motor controller.

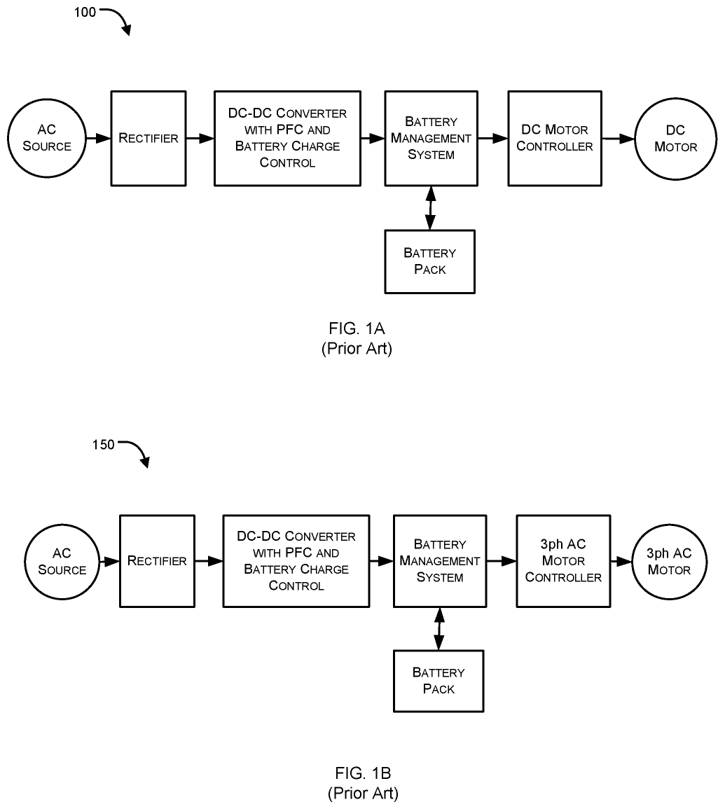

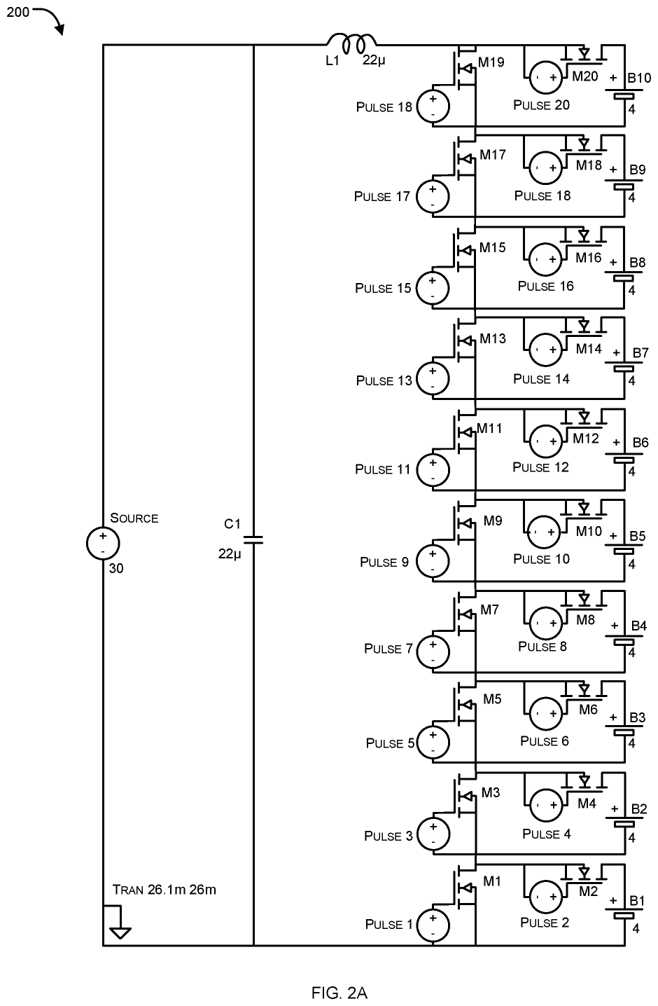

FIG. 1A illustrates as in prior art a conventional electric vehicle power system 100 with DC motor and FIG. 1B indicates as in prior art a conventional electric vehicle power system 200 with AC motor respectively, in accordance with an embodiment of the present disclosure.

As shown in FIG. 1A is a conventional electric vehicle power system where a DC Motor is used. Further, as shown in FIG. 1B is a conventional electric vehicle power system where an AC Motor is used. As shown, the conventional electric vehicle power system requires dual circuits for performing multi-functions such as battery balancing, battery charging and AC motor controlling.

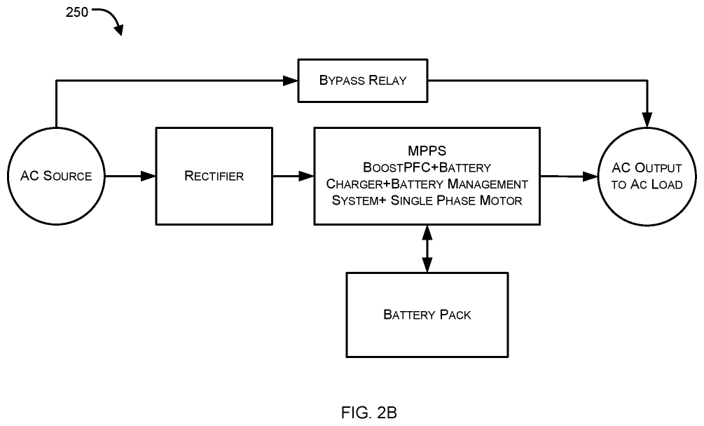

FIG. 2A illustrates a circuit 200 for the MPPS system, and FIG. 2B indicates the MPPS based single phase power backup inverter 250 in accordance with an embodiment of the present disclosure.

In an embodiment, as shown in FIG. 2A is the MPPS system. The system comprises elements such as but not limited to a circuit, a set of batteries connected serially in a battery array (also referred to as battery array herewith), an inductor, and a power source. The MPPS circuit can facilitate battery management in terms of managing both battery charging and discharging. As shown in FIG. 2A all the batteries of the battery array can be connected serially. Each battery of the battery array is provided two metal-oxide-semiconductor field-effect transistor (MOSFET) switches. One of the switches is of an odd number, and the other switch is of an even number. As an example the battery B1 can have switch M1 as odd switch and switch M2 as even switch. Both the switches can be controlled by a Microcontroller (MCU) signal generated for the battery. As an example for 10 numbers of the battery array a 10 bit signal is provided by the MCU, with a 1-bit signal for each of the battery of the battery array. When the MCU bit is ‘0’ then odd switch of the corresponding battery is switched ‘ON’ and the battery shall be disconnected from the array stack and can provide bypass path to the adjacent battery. When the MCU bit is ‘1’ then even switch of the corresponding battery is set as ‘ON’ and the battery shall be connected to the array stack and shall add battery cell voltage in an array voltage. For each of the battery their odd and even switches can be complimentary such that when the odd switch is switched ‘ON’ then even switch will be turned ‘OFF’ and vice-versa. So by connecting each of the battery to the array stack the circuit can allow to charge/discharge from that battery and by disconnecting the battery the circuit can provide rest to that battery.

In an embodiment, the MCU signal can be provided to each of the cell in a particular sequence. Further, in order to balance the batteries of the battery array, during charging, the batteries with higher State Of Charge (SOC) can be provided more rest, and in discharging batteries, the battery which has the lower SOC can be provided more rest. This technique can be used for cell balancing in the MPPS circuit. The MPPS circuit cannot just do cell balancing (Battery Management), but it can also do dual functions at a same time. For example during charging the circuit controls simultaneously both battery cell charge current and battery balancing, and during discharging the circuit controls output voltage and current with required wave shape and simultaneously also does battery management. Also during discharging output wave shaping can be done by without any magnetic filter. And at both the times (charging and discharging) dual function can be performed by the same MPPS circuit. As can be appreciated by one skilled in the art, a first function of the MPPS circuit is battery management and a second function is charging or discharging.

In an embodiment, the battery management can be done by switching each of the even switch and the odd switch alternatively. For example, when the MCU bit is ‘0’ then odd switch of the corresponding battery is switched ‘ON’ and the battery shall be disconnected from the array stack and can provide bypass path to the adjacent battery. Further, when the MCU bit is ‘1’ then even switch of the corresponding battery is set as ‘ON’ and the battery shall be connected to the array stack and shall add battery cell voltage in an array voltage. For each of the battery their odd and even switches can be complimentary such that when the odd switch is switched ‘ON’ then even switch will be turned ‘OFF’ and vice-versa. So by connecting each of the battery to the array stack the circuit can allow to charge/discharge from that battery and by disconnecting the battery the circuit can provide rest to that battery. The MCU signal can be provided to each of the cell in a particular sequence.

In yet another embodiment, as shown in FIG. 2A is the MPPS circuit. As shown in the MPPS circuit are batteries B1 to B10. Each of the battery is connected to battery array via the two switches, for example B1 has two MOSFET switches M1 and M2, and both of the switches can be complimentary On/Off with dead band during switching. When switch M2 is ON (switch M1 is off) the battery B1 is connected to the battery array, and when switch M2 is OFF (switch M1 is on) the battery B1 is disconnected from the battery array and the battery array series are connected through the M1 switch. Further, as shown the switch M1 to M20 are part of the MPPS circuit for a 10 stack array battery. For example, a 100 battery array can require M1 to M200 MOSFET switches and 230 VAC system can require around 100 battery array stack (with nominal 3.7V cell voltage for each of the battery). For simplification we have considered and shown here a battery array with 10 batteries where each of the battery has 4V power. For 230 VAC circuit AC source rectified voltage will be around 300V to 330V range, but for simplification in the illustrated circuit example we have shown 30V as a rectified voltage. The charging can be shown in two different modes. Further, based on SOC levels of a battery cell, one of a battery cell out of the 10 battery cells arranged in series can be kept on rest. However, when number of batteries connected in series is greater than ten, the system can choose to keep more than one battery cell in rest as per the SOC value of the battery cell. As an example, in case of a 50 battery cell array the system can keep multiple battery cells (such as 4-5 battery cells) to rest such that there is less than 10% drop in the array stack voltage.

In another embodiment, in charging mode the MPPS circuit can also work like a charger. As explained in the prior art, in-order for the circuit to work as a battery charger from an AC power source, the circuit needs a rectifier and a DC-DC converter. The rectifier converts the AC voltage to the DC voltage and the DC voltage varies as per the AC source voltage. The rectified DC voltage cannot be matched with the required DC voltage of the battery array, and the rectified voltage can vary as per the AC voltage variation and the battery array voltage varies as per the battery SOC levels. Hence, a DC/DC converter may be required to match the voltages. In-order to take the AC current from the AC power source a PFC DC/DC converter can be required. Further, to maintain a continuous input current a boost topology can be used and can be called as boost PFC DC/DC converter. The boost PFC converter can control the input AC current and the output current and voltage as per the battery charge level with resolution in mV and mA level. Furthermore, a simple switch network can only control voltage as per the single battery cell level voltage resolution (for example 3-4V level for lithium-ion cell), and can create high current spike, as battery cells having series resistance in the mV level. The invention facilitates providing dual solutions for the same. Here, in the MPPS circuit an additional inductor L1 is provided, and the MPPS circuit can create and act as a boost converter that facilitates performance of the circuit similar to that of a boost. The below examples 40 VDC battery stack charged with 30 VDC source.

In an embodiment, the MPPS circuit can perform and produce results similar to that of a boost. As illustrated all the odd switches M1, M3 . . . M19 of the MPPS circuit can be controlled by a similar Pulse Width Modulation (PWM) signal generated from the MCU. So, when all the odd switches are turned ON simultaneously the voltage difference across inductor L1 is set around 30V (assuming that the voltage drops by all odd MOSFETs are zero). During this time an inductor configured to the battery array can store energy and current produced therewith increases by dI (delta I) value, similar to as that in a common boost circuit. When the odd switches get turned OFF, the complimentary even switches can get ON and the inductor charge current can flow through all the batteries of the battery array. The current from the battery array can be increased by increasing the duty cycle of the odd switches, and the charge current can be decreased by decreasing the duty cycle of the odd switches.

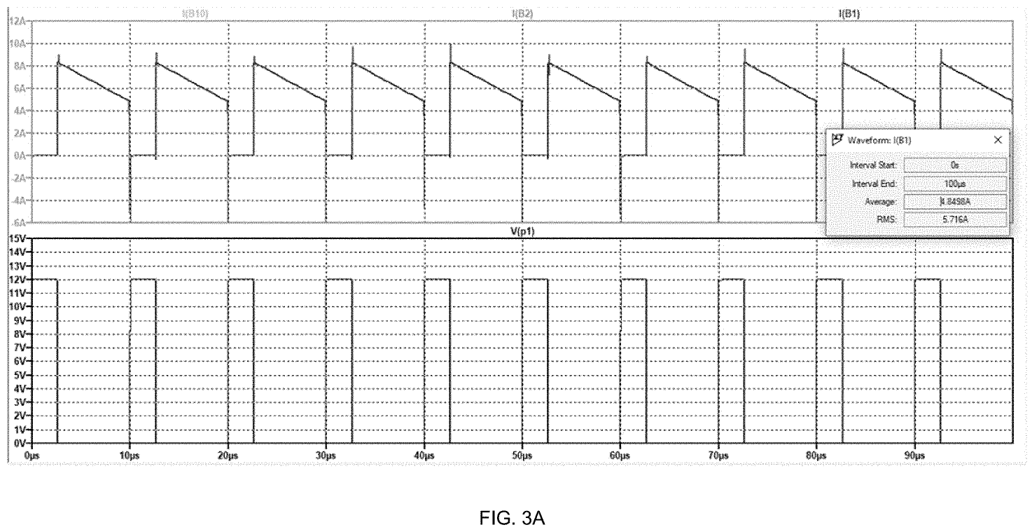

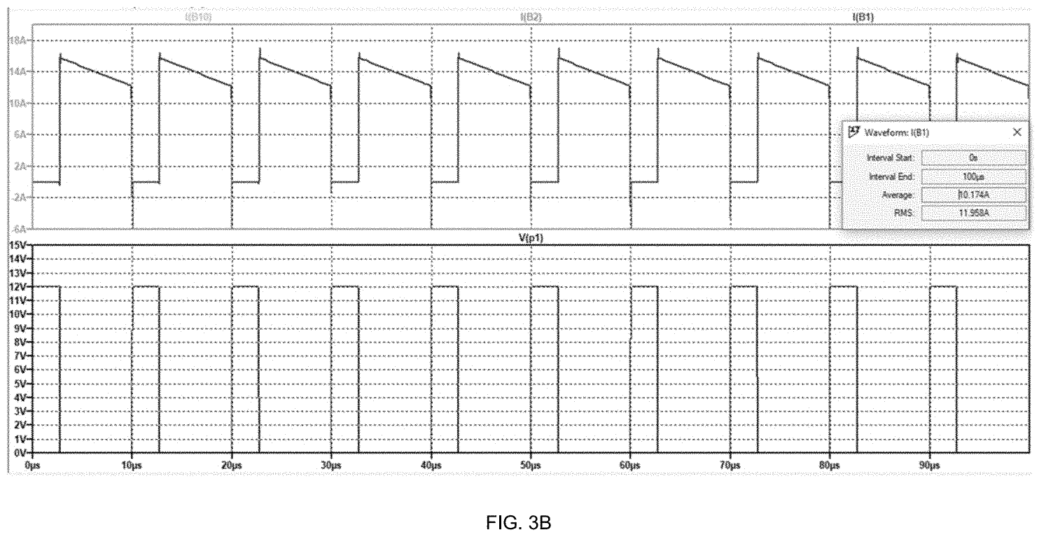

FIG. 3A illustrates a waveform 300 with charge current as 5 A, and FIG. 3B illustrates a waveform 350 with charge current as 10 A, in accordance with an embodiment of the present disclosure.

In an embodiment, as shown in FIG. 3A and in FIG. 3B two waveforms are illustrated. As shown in FIG. 3A and FIG. 3B, the charge current can be changed from 5 A (FIG. 3A) to 10 A (FIG. 3B) by changing the odd switches duty cycles from 26% (for FIG. 3A) to 27% (FIG. 3B), with dead band of 2%. So by adjusting the duty cycle the battery charge current can be controlled in a Current Constant (CC) mode and the battery voltage can be controlled in a Current Variable (CV) mode.

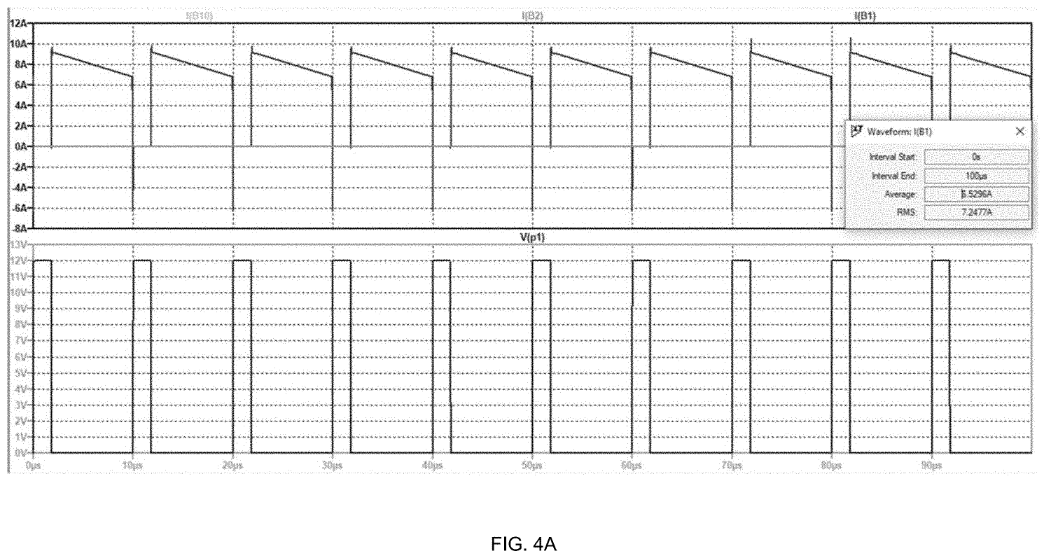

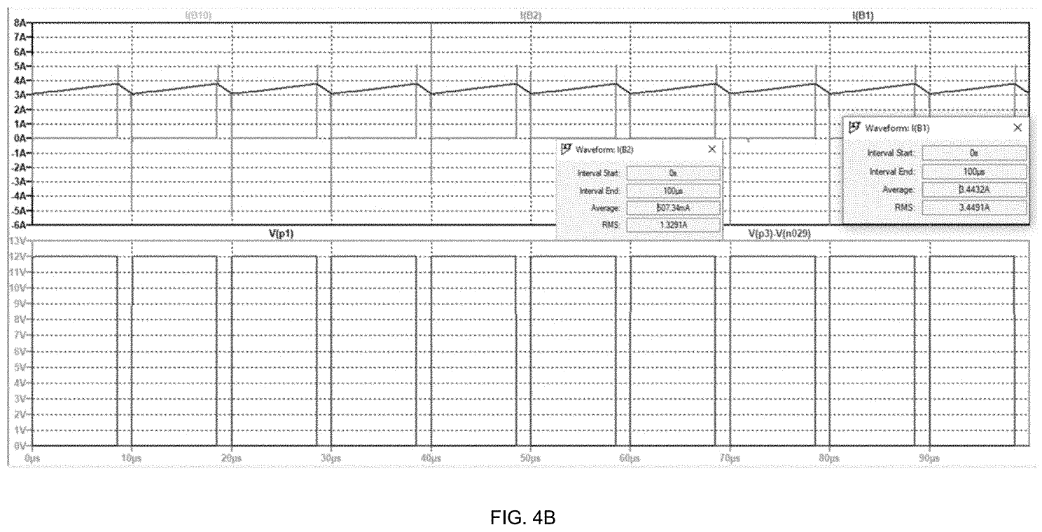

In an embodiment, the present invention facilitates managing the batteries of the battery array. As described, the battery management can be done such as in two modes. As in a first mode, for the battery management—more rest can be provided to the battery present in the battery array, with high SOC by making odd switch ON for 100% duty cycle and even switch OFF (i.e. with 0% duty cycle) for that battery. As shown in FIG. 4A is an example for the resting battery B2. During this time the resting battery B2 can be disconnected (with 100% duty cycle for P3) with 0 A charge current. At this time, the remaining set of the batteries can be charged with 6.5 A current with 18% duty cycle for all of the rest of the odd switches other than P3. By performing the rest, the battery's charge level can reach equal to charge level of the battery B2 after some time duration.

In an embodiment, furthermore, a second mode is provided for the battery management. As in the second mode—the batteries which are required to be charged with lower current rate are switched by Pulse Width Modulation (PWM) signal for pulse charging and rest all of the batteries are connected to the battery array by 100% even switch duty cycle for DC charging. As an example, the batteries B2, B3 and B6 can be charged with 0.5 A average pulse current with odd switch P3, P5, P11 having duty cycle of 85%, and remaining all of the batteries can be charged with 3.5 A average DC current. The battery with odd switch has the duty cycle of 0% for P1, P7, P9, P13, P15, P17 and P19. The example has been shown as in FIG. 4B and facilitates illustrating the battery balancing while charging the battery both in the CC and the CV mode and the charging can be achieved by using a pulse duty cycle adjustment.

As shown in FIG. 2B is a block diagram for a single phase power backup inverter. The block diagram in FIG. 2B shows a single MPPS circuit that performs functions such as charging and discharging with output voltage control and battery management. Further, the block diagram shows an AC source input with a bypass relay that delivers power to an AC output to AC load block. Additionally, the power is delivered to a rectifier and then passed on to the proposed MPPS circuit (that includes providing boost PFC, battery charger, battery management system and single phase inverter function). The MPPS circuit can be provided back up from a connected battery pack. The power received from the MPPS circuit can then be delivered to the AC output to AC load block.

FIG. 4A illustrates a waveform 400 for resting battery cell B2, and FIG. 4B illustrates a waveform 450 with average DC current in the battery with odd switch duty cycle, in accordance with an embodiment of the present disclosure.

In an embodiment, for performing in a single phase inverter mode the MPPS circuit can create a half sine wave by varying a number of batteries present in the battery array at different instances according to a sine amplitude value.

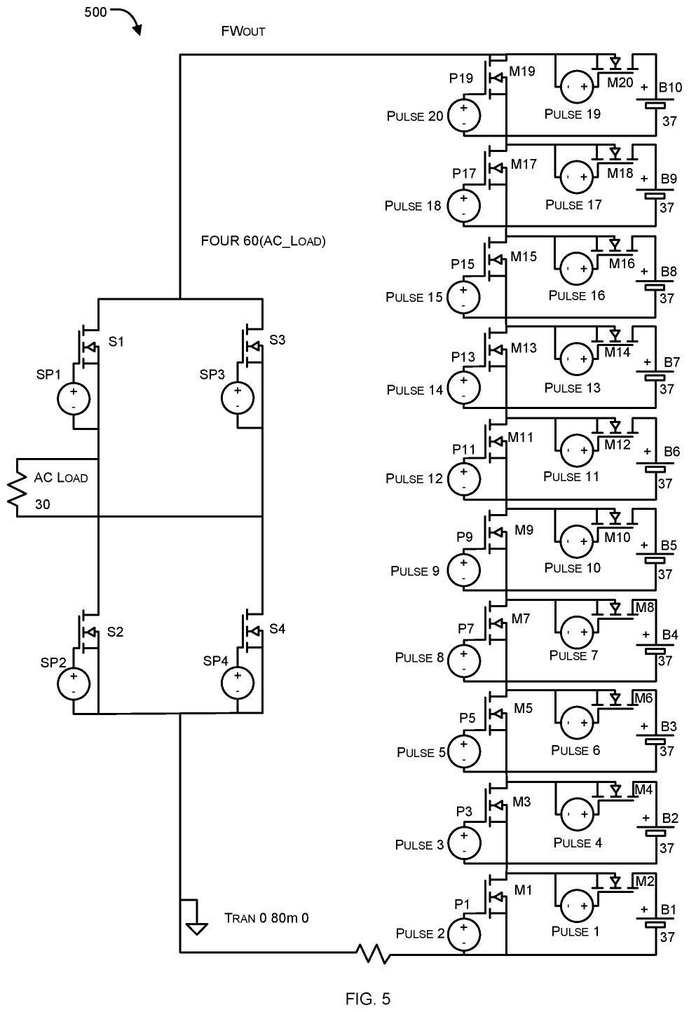

FIG. 5 illustrates the MPPS system based single phase inverter, in accordance with an embodiment of the present disclosure.

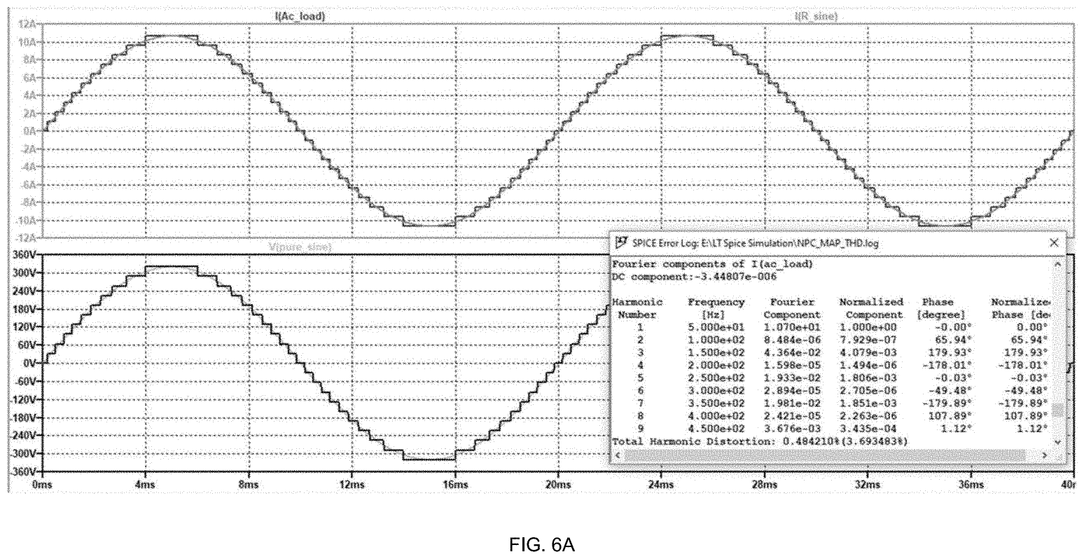

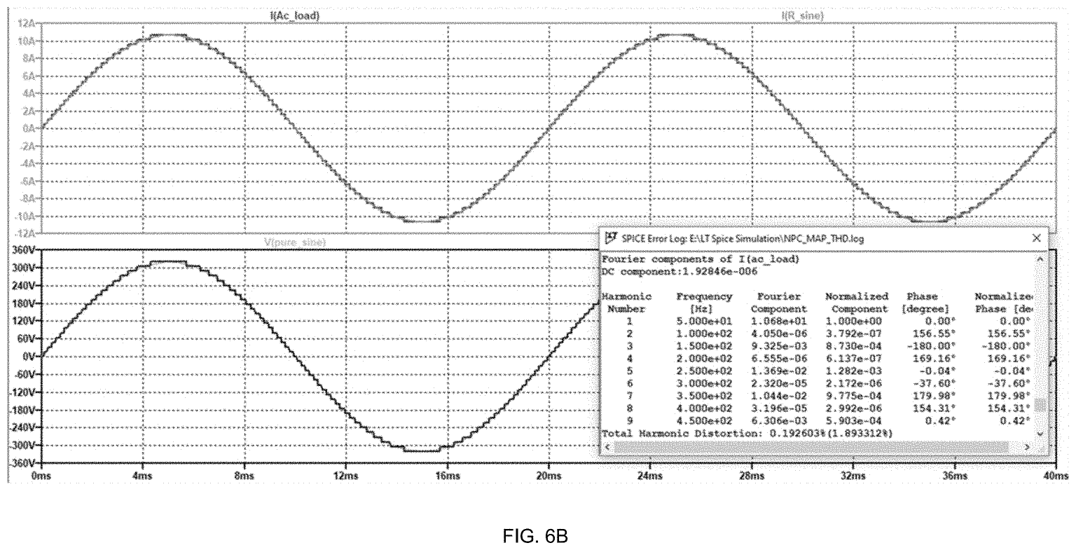

As shown in FIG. 5, there is shown an additional high voltage H-Bridge that is required in-order to make it full sine wave. In the H-Bridge with the MPPS circuit a low speed switch with around 50 Hz to 60 Hz switching speed is shown. However, in a conventional inverter, a switch should be of a high switching speed with low conduction losses which are very costlier than the H-Bridge used here. In the proposed invention, no addition of a bulky magnetic filter is required to the MPPS circuit. The circuit can however, directly create the sine wave without using the magnetic filter. In case of a conventional inverter a sine modulated high voltage PWM is created by using a switching circuit that needs be integrated in the circuit by bulky magnetic filter to make sine wave. As shown in FIG. 6A is the MPPS circuit for a single phase 21 level inverter with 10 numbers of battery sources and THD below 0.5%. As per most of the standard acceptable the THD should be below 5%, as lower threshold shows an efficient circuit. Further, as shown in FIG. 6A is a 41 level MPPS Inverter with 20 batteries cell source with THD <0.2%. As shown, by increasing the number of battery sources, an output sine wave quality improves by reducing the THD %.

FIGS. 6A-B illustrates a waveform for illustrating low voltage MPPS switches operating at less than 1 KHz switching frequency and generating output voltage with battery cell voltage level resolution, in accordance with an embodiment of the present disclosure.

In an embodiment, as shown in FIGS. 6A and 6B a low voltage MPPS switch operating at less than 1 kHz switching frequency and output voltage, can generate with battery cell voltage level resolution.

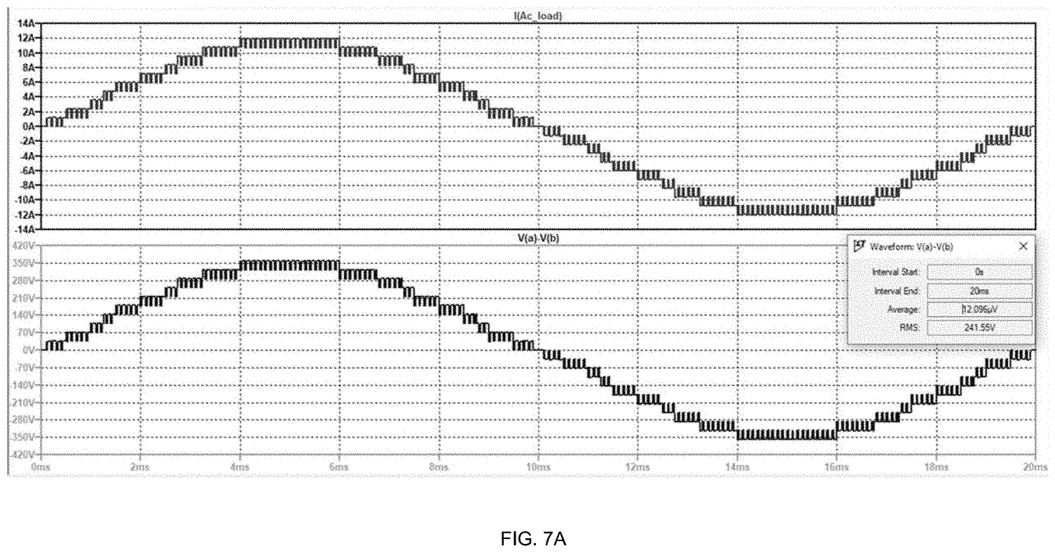

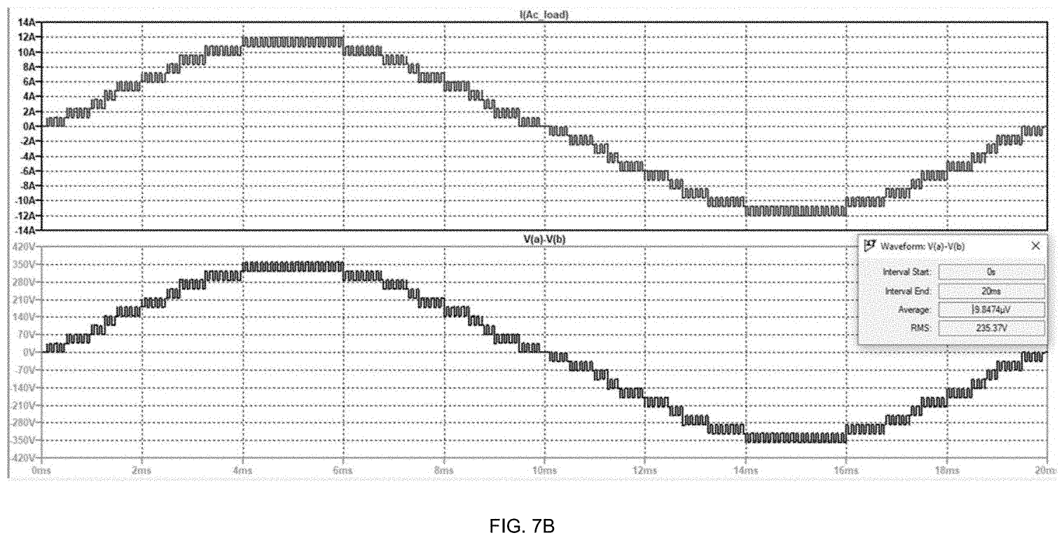

FIG. 7A illustrates a waveform 700 generated by adjusting modulation index of sine modulated PWM at 0.7 and FIG. 7B illustrates a waveform 750 generated by adjusting modulation index of sine modulated PWM at 0.5 in accordance with an embodiment of the present disclosure.

In an embodiment, to achieve better resolution in the output voltage and the current, the proposed MPPS circuit can provide sine modulated PWM to one of the battery of the battery array. In this case, a low voltage sine modulated PWM will be superimposed on the multi-level sine waveform as shown in FIGS. 7A and 7B. Here the sine wave voltage and the current can be varied by adjusting modulation index of sine modulated PWM from 0.7 to 0.5. As can be appreciated by one skilled in the art the presented current regulation technique can be used in a hybrid solar grid tie inverter for grid feeding current control. As shown in FIG. 7A is a low voltage sine modulated PWM that is superimposed on the multi-level sine waveform. The parameters for the wave of FIG. 7A are such as but not limited to:

P2 Sine Modulated PWM Modulation Index: 0.7

VAC (Va-Vb)=241.55V (RMS)

IAC_Load=8.05 A (RMS)

Load=30 Ohm

Further, the parameters for the wave of FIG. 7B are such as but not limited to:

P2 Sine Modulated PWM Modulation Index: 0.5

VAC (Va-Vb)=235.37V (RMS)

IAC_Load=7.85 A (RMS)

Load=30 Ohm

The battery cell balancing during the MPPS circuit inverter discharge is made possible by providing more rest to the less charged battery and less rest to the high charge state battery.

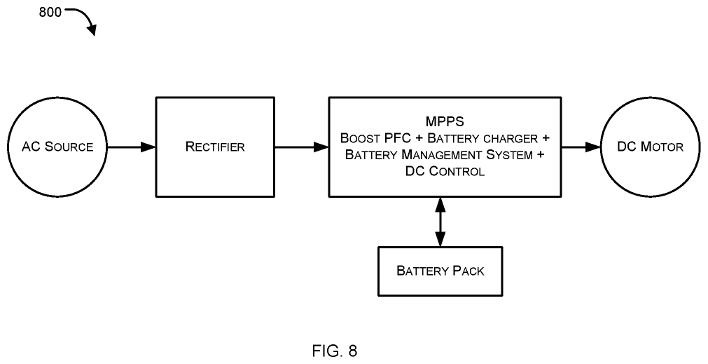

FIG. 8 illustrates a proposed MPPS based EV power system 800 with DC motor, in accordance with embodiments of the present disclosure.

In an embodiment, as disclosed in FIG. 8 is the MPPS circuit based Electric Vehicle (EV) power system for a DC motor. The circuit comprises a battery charger with Boost PFC, a battery management unit (system) for cell balancing, and a DC motor control. In the MPPS circuit a set of modular hardware switches can be programmed so that the circuit function like a charger and manages battery during charging. During the EV running on road, the provided DC motor controller provides required power to the DC motor load, and during this time the MPPS circuit facilitates battery management and controlling of the DC motor controller. As can be appreciated by one skilled in the art, the MPPS circuit can perform the battery charging function in the same way as discussed in earlier embodiments.

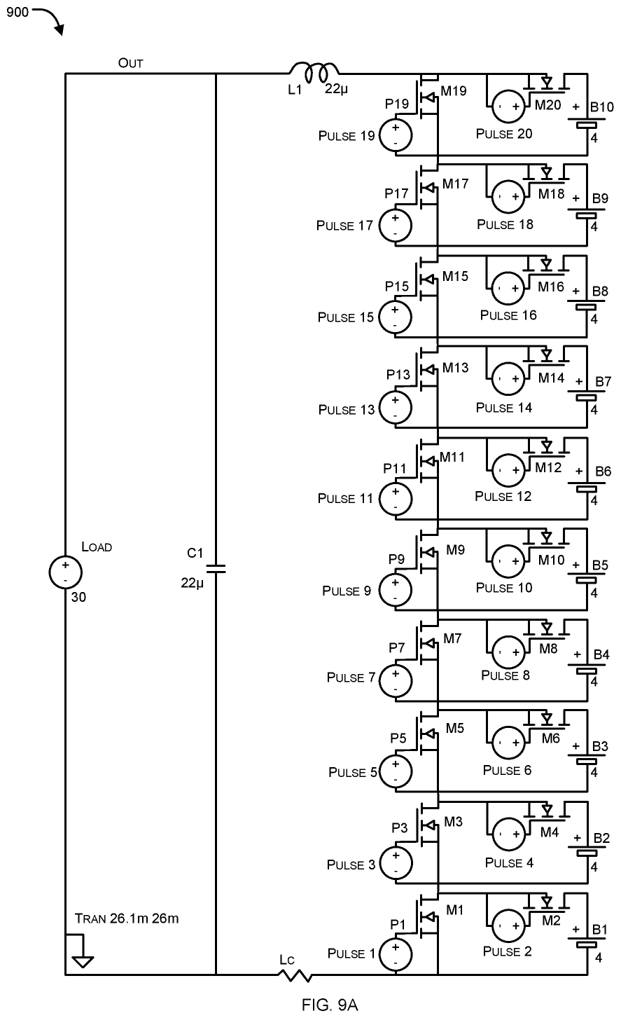

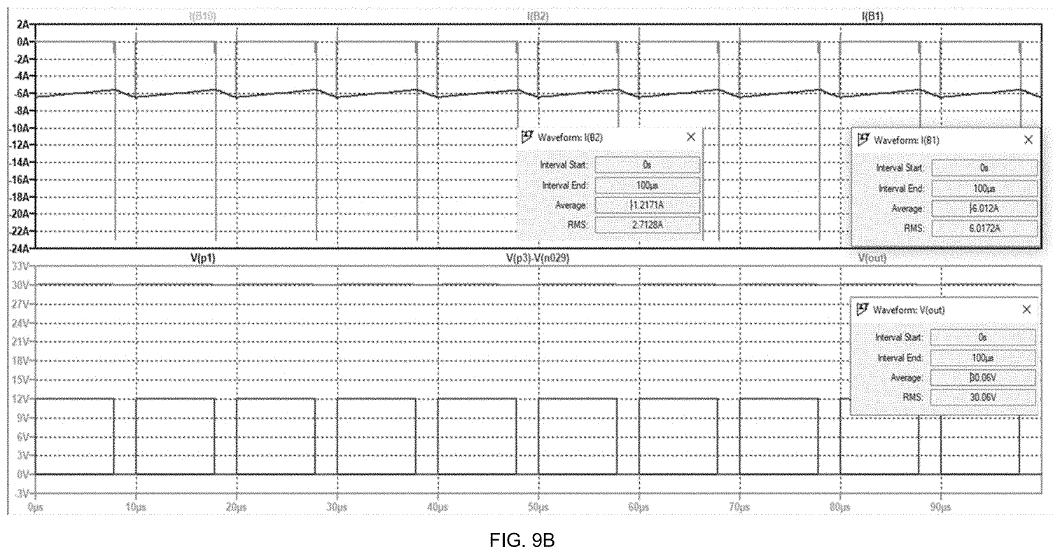

FIG. 9A illustrates a circuit 900 for showing discharge to motor controller duty cycle controlling modes and FIG. 9B illustrates a waveform 950 generated during battery discharging, in accordance with an embodiment of the present disclosure.

In an embodiment, a battery discharging function for the DC motor control for the EV is disclosed. As shown in FIG. 9A is a control of the discharge for the motor controller duty cycle controlling modes. As can be appreciated by one skilled in the art, the MPPS circuit can work like a bi-direction buck-boost circuit and during charging it can work like a source to battery boost circuit. Further, during discharging to DC load the circuit can work like a battery to load buck circuit. Additionally, the battery management can be done by resting the time variation as discussed in previous embodiments. As shown in FIG. 9B is a graph showing DC motor control during battery discharging. The parameters used as in the shown graph are as follows:

B1, B4, B5, B7, B8, B9 & B10 with DC discharging

Duty Cycle P1, P7, P9, P13, P15, P17, P19=0%

B2, B3 & B6 with pulse discharging

Duty Cycle P3, P5, P11=78%

Dead Band=2%

As shown in FIG. 9B is a controlled DC load voltage at 30V with drawing differential current from each of the battery. Battery B2, B3 and B6 are discharged at a lower current rate of 1.2 A current with assumed lower SOC values, so as to not get deep discharge. Remaining batteries with assumed higher SOC values are discharged at higher discharge current 6 A. The graph as shown in FIG. 9B can be achieved with the second mode as discussed in previous embodiments.

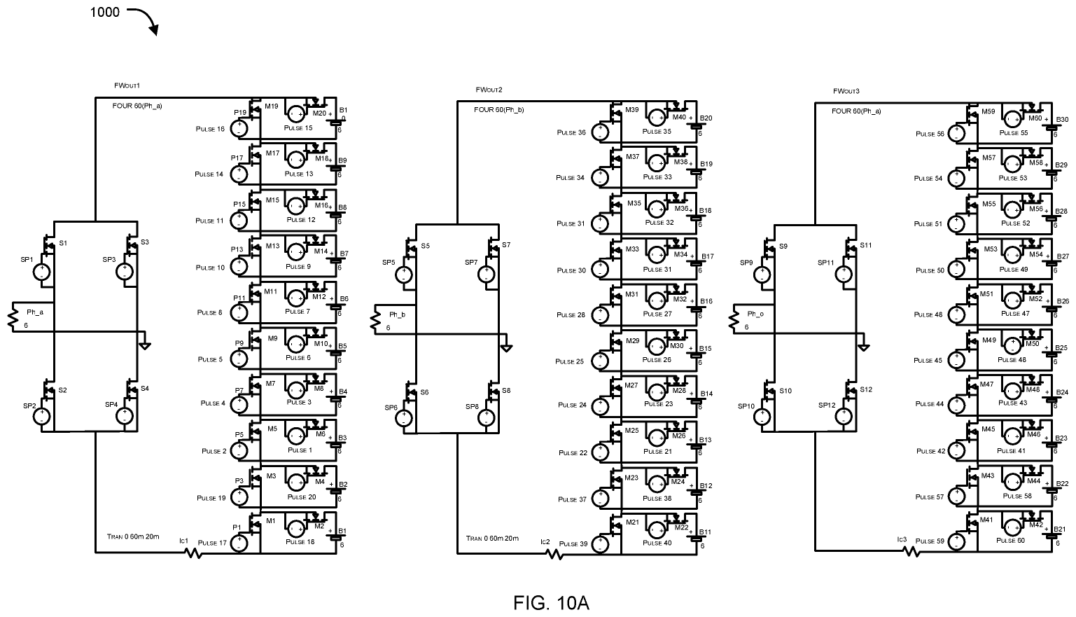

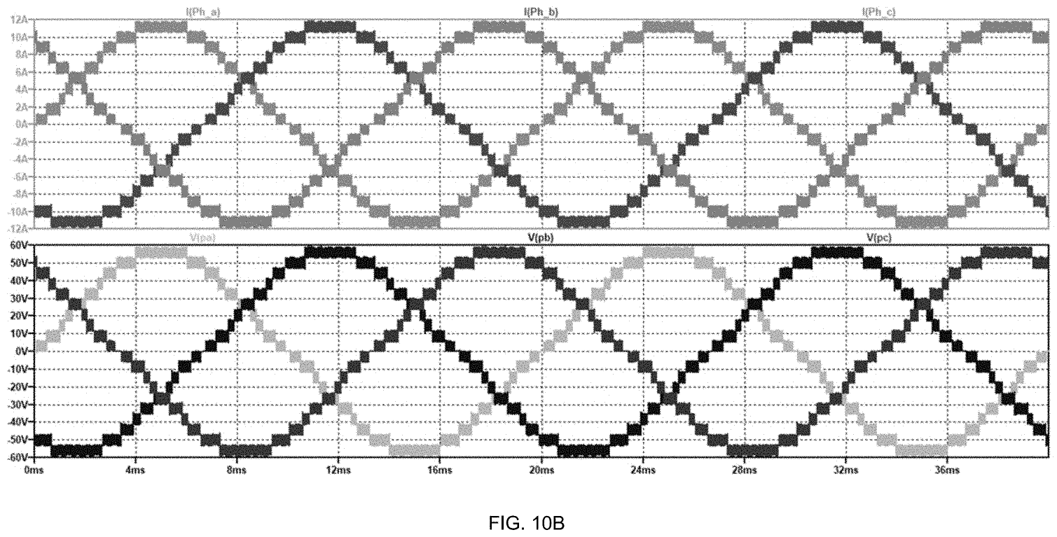

FIG. 10A illustrates at 1000 a 3-phase AC motor controller with three battery arrays and three MPPS circuits and FIG. 10B illustrates at 1050, a 3 phase AC motor control current and voltage waveforms by providing sine modulated PWM in single source of each phase, in accordance with an embodiment of the present disclosure.

In an embodiment, the disclosed MPPS circuit based EV Power system for AC motor, battery charger with boost PFC, battery management system (cell balancing), and three phase AC motor control all functions can be performed by three parallel MPPS circuits with phase shift. In the MPPS circuit there can be a set of modular hardware switches which can be programmed so that it functions like a charger and battery manager during charging. During the EV running on road, the motor controller can provide required power to the AC motor load, and during this time the MPPS circuit can function like the battery manager and as an AC motor controller. In an embodiment, for the battery charging, the three MPPS circuits can be placed in parallel and can perform battery charging functions independently. Further, for the battery charging in the AC motor control for the EV a 3-phase AC motor controller with three battery, battery array and three number of MPPS circuit is provided and is shown in FIG. 10A. As shown, the three phase output node is shown with name of Pa, Pb and Pc for phase-a, phase-b and phase-c respectively. The MCU can generate a phase zero (zero angle) signal, while the phase-b and the phase-c generates their PWM signals with 120 degree and 240 degree phase shift from phase-a respectively. Remaining functioning for each of the phase can be done by the MCU independently as discussed in earlier embodiments under the single phase inverter mode. Furthermore, FIG. 10B illustrates 3-phase AC motor control current and voltage waveforms achieved by providing as input a sine modulated PWM in a single source of each phase.

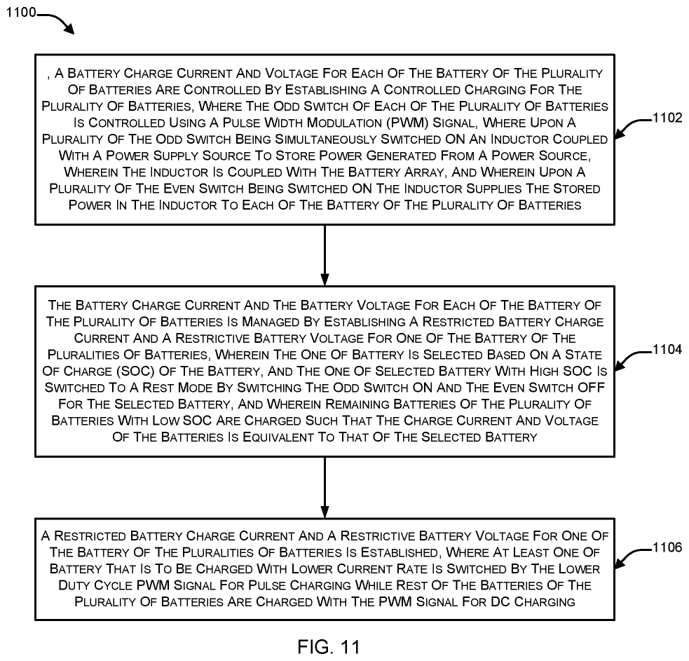

FIG. 11 illustrates an exemplary flow diagram 1100 of the proposed method for maintaining charge control of a battery array, in accordance with an exemplary embodiment of the present disclosure.

In an embodiment, a technique for maintaining charge control of a battery array where a plurality of batteries are serially connected and each of the battery has an odd switch and an even switch is discussed. At block 1102, a battery charge current and voltage for each of the battery of the plurality of batteries are controlled by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries. At block 1104, the battery charge current and the battery voltage for each of the battery of the plurality of batteries is managed by establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery. Further at block 1106, a restricted battery charge current and a restrictive battery voltage for one of the battery of the pluralities of batteries is established, where at least one of battery that is to be charged with lower current rate is switched by the lower duty cycle PWM signal for pulse charging while rest of the batteries of the plurality of batteries are charged with the PWM signal for DC charging.

In an embodiment, the battery array can include a plurality of batteries, each of the batteries connected via a battery string. Within each battery array the batteries can be connected in either series or in parallel. The batteries can be implemented with various different types of rechargeable batteries made of various materials, such as lead acid, nickel cadmium, lithium ion, or other suitable materials. In some embodiments, each of the battery can output about 375V-400V if charged about 80% or more.

In an embodiment, a one or more switches can be configured to connect the battery strings to power source or disconnect the battery strings from the power sources in response to received respective control signals. The switches can be implemented with any suitable contactors capable of handling the level of current and voltage as needed in connection with, for example, the battery strings, the power buses and the load within the electric vehicle. In some embodiments the switches can be implemented with mechanical contractors or other suitable electrical switching devices. In an embodiment, the switches can be controlled either by respective positive bus connect control signals or by respective negative bus connect control signals.

As disclosed herein, it can be advantageous to initiate or stop the battery charging to account for varying levels of operational voltages and maximize power output while minimizing damage or wear and tear resulting from repeated usage of the battery. The adaptive initiating or stopping of the battery charging as disclosed herein can minimize intermediate current flowing in and out of the battery array. Further, using the multiple batteries as disclosed herein can be advantageous to allow adaptive operation using less than full voltage source power, continuous operation of the electric vehicle despite local battery faults. Furthermore, the initiation and stopping of the battery charging can be digitally and intelligently controlled, optimal sequence of connections, various timing windows or waiting times, the threshold or delta voltages, or other similar variables can be adjusted according to system requirements and specification.

In an embodiment the circuitry can include a plurality of passive and/or active circuit elements, signal processing components, such as analog-to-digital converters (ADCs), amplifiers, buffers, drivers, regulators, or other suitable components. In some embodiments, the circuitry can also include one or more processors to process incoming data to generate outputs, such as control signals. In some embodiments, the control circuit can also include one or more components for communicating and sending and receiving data with other circuitries in the electric vehicle. For example, the various components and circuits within the electric vehicle, including components in the circuitry can be in communication with one another using protocols or interfaces such as a CAN bus.

In an embodiment, a cascade multi-level inverter circuit is shown, that can be simulated for all charging and discharging functions. As shown, no additional H-Bridge circuit may be required for an inverter function. Four MOSFET switches can be applied for each of the battery of the battery array instead of two switches as proposed earlier. In the circuit during the charging and the DC load control in the battery discharge two additional switches can create extra losses in terms of heat and power dissipation.

In an embodiment, the disclosed MPPS circuit can be used for the battery cell balancing, charging, discharging and battery management. As disclosed, the single MPPS circuit can perform multiple functions as per requirements such as related to integration and control of high voltage and low voltage, low power switch control to achieve high voltage and high power solutions. The disclosed MPPS circuit can be of a compact size with high performance and a single controller unit for multiple power paths.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, to avoid obscuring the present invention.

While the foregoing describes various embodiments of the disclosure, other and further embodiments of the disclosure may be devised without departing from the basic scope thereof. The disclosure is not limited to the described embodiments, versions or examples, which are included to enable a person having ordinary skill in the art to make and use the disclosure when combined with information and knowledge available to the person having ordinary skill in the art.

The present disclosure provides a method and system for battery management for balancing, charging, and discharging of the batteries of a battery array.

The present disclosure provides a method and system for integration and control of large low voltage, low power switch control to achieve high voltage and high power solutions.

The present disclosure provides a method and system for providing a compact size high performance power system.

The present disclosure provides a method and system for providing a single controller unit for multiple power paths.

The present disclosure provides a method and system for disconnecting individual batteries from battery array during run time.

The present disclosure provides a method and system for managing charge control of a battery array.

The present disclosure provides a method and system for managing battery array that provides power backup of electric vehicles where power backup for the electric vehicles is provided as lithium-ion cells.

The present disclosure facilitates supporting large mismatch batteries to allow using low cost mismatched battery from the battery array.

What is claimed is:

1. A method for maintaining charge control of a battery array where a plurality of batteries are serially connected and each of the battery has an odd switch and an even switch, said method comprising:
controlling a battery charge current and voltage for each of the battery of the plurality of batteries by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries; and,
managing the battery charge current and the battery voltage for each of the battery of the plurality of batteries by:
establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery; and,
establishing a restricted battery charge current and a restrictive battery voltage for one of the battery of the pluralities of batteries, where at least one of battery that is to be charged with lower current rate is switched by the lower duty cycle PWM signal for pulse charging while rest of the batteries of the plurality of batteries are charged with the higher duty cycle PWM signal for DC charging.

2. The method as claimed in claim 1, wherein upon the odd switch being turned OFF one or more complimentary even switch of the battery array turns ON such that the generated power from the inductor flows through the battery array.

3. The method as claimed in claim 1, wherein the plurality of batteries is serially connected via a switch circuit.

4. The method as claimed in claim 1, wherein the plurality of batteries are connected in series using a string and are disconnected by creating a bypass path for the string.

5. The method as claimed in claim 1, wherein the method facilitates creating a full sine wave by varying a count of the pluralities of batteries.

6. The method as claimed in claim 1, wherein the inductor configured with the battery array facilitates the battery array to act as a boost converter.

7. The method as claimed in claim 1, wherein the even switch and the odd switch are controlled using a Metal Oxide Semiconductor Field Effect Transistor (MOSFET).

8. The method as claimed in claim 1, wherein the PWM signal is received from a microcontroller.

9. A system for maintaining charge control of a battery array where a plurality of batteries are serially connected and each of the battery has an odd switch and an even switch, said system comprising:
one or more processors, communicatively coupled to a memory, the memory storing one or more instructions executable by the one or more processors, wherein the one or more processors upon execution of the one or more instructions causes the system to:
control a battery charge current and voltage for each of the battery of the plurality of batteries by establishing a controlled charging for the plurality of batteries, where the odd switch of each of the plurality of batteries is controlled using a Pulse Width Modulation (PWM) signal, where upon a plurality of the odd switch being simultaneously switched ON an inductor coupled with a power supply source to store power generated from a power source, wherein the inductor is coupled with the battery array, and wherein upon a plurality of the even switch being switched ON the inductor supplies the stored power in the inductor to each of the battery of the plurality of batteries; and,
manage the battery charge current and the battery voltage for each of the battery of the plurality of batteries by:
establishing a restricted battery charge current and a restrictive battery voltage for one of the battery of the pluralities of batteries, wherein the one of battery is selected based on a State Of Charge (SOC) of the battery, and the one of selected battery with high SOC is switched to a rest mode by switching the odd switch ON and the even switch OFF for the selected battery, and wherein remaining batteries of the plurality of batteries with low SOC are charged such that the charge current and voltage of the batteries is equivalent to that of the selected battery; and,
establishing a restricted battery charge current and a restrictive battery voltage for one of the battery of the pluralities of batteries, where at least one of battery that is to be charged with lower current rate is switched by the lower duty cycle PWM signal for pulse charging while rest of the batteries of the plurality of batteries are charged with the PWM signal for DC charging.

10. The system as claimed in claim 9, wherein the system is located on a printed circuit board.
